(19) United States
(12) Patent Application Publication
(10) Pub. No.: US 2018/0060909 A1
(43) Pub. Date: Mar. 1, 2018

(54) METHOD AND SYSTEM FOR GENERATING TARGETED MARKETING OFFERS

(71) Applicant: BUBBLES ONLINE SERVICES LTD, Alton, Hampshire (GB)

(72) Inventors: Martin Edward ADAMS, Romsey, Hampshire (GB); Julian Ashley Edward FISHER, Newton Valence, Hampshire (GB)

(21) Appl. No.: 15/561,327

(22) PCT Filed: Mar. 29, 2016
(86) PCT No.: PCT/GB2016/050879

§ 371 Date: Sep. 25, 2017

Related U.S. Application Data
(60) Provisional application No. 62/138,178, filed on Mar. 25, 2015.

(51) Int. Cl. G06Q 30/02; G06Q 20/10

(52) U.S. Cl. CPC G06Q 30/0255; G06Q 30/0267; G06Q 30/0261; G06Q 30/0281; G06Q 30/0252; G06Q 30/0269; G06Q 30/0277; G06Q 20/10

(57) ABSTRACT

The present invention relates to a method, system and server for generating targeted marketing offers for users of mobile devices using the user's historical online retail browsing activity. When a user is within a physical retail store, a customised marketing offer is generated for a user based upon this activity and transmitted to the user's mobile device.

### FIELD OF INVENTION

The present invention is in the field of targeted marketing offers. More particularly, but not exclusively, the present invention relates to the generation of targeted marketing offers based upon online activity.

### BACKGROUND

Advertising is used by retailers to drive consumer traffic and product sales. In the online world, the most common advertising are banner advertisements where an advertising content network purchases advertising space for retailers across a network of content providers and delivers advertisements to browsers of those content providers in the form of text and/or graphics.

Traditionally there was limited relevance to a typical user browsing a content provider except, perhaps, where the content provider limited the types of advertisements that can be provided.

Advertisement content networks typically track a user across their network of content providers. Advertisement content network providers are now using this tracking information to deliver targeted advertising to users based upon their browsing history across the content network.

However, this targeting is very coarse as it only tracks which web-pages have been viewed rather than more complex interaction within each website. Furthermore, it can only directly drive online sales and not in-store sales.

Another method by which retailers seek to drive product sales are by capturing consumer email details and sending marketing offers (such as coupons) via email. These marketing offers may be targeted based upon demographic data or historical purchases made by the consumer. Recipients of the marketing offers can utilise these offers in-store for discounts, for example, in purchasing products. However, these offers do not utilise online activity and may be ultimately forgotten by the recipient when they are next within the physical retail store.

There is a desire for a system which can deliver targeting marketing offers based upon online activity in a way which maximises product sales for retailers.

It is an object of the present invention to provide a system which overcomes the disadvantages of the prior art, or at least provides a useful alternative.

### SUMMARY OF INVENTION

According to a first aspect of the invention there is provided a method for generating targeted offers to a user of a mobile device, including:

a) capturing user browsing information at a retail web server;
b) retrieving a token associated with the user from a server;
c) storing an association between the token and the browsing information at the retail web server;
d) at a user's mobile device, detecting one or more signals transmitted within a physical retail store;
e) extracting store identifier information from the one or more signals;
f) at the server, retrieving browsing information from the retail web server using the store identifier information and a user identifier;
g) at the server, generating a targeted marketing offer for the user based upon, at least, the retrieved browsing information; and
h) transmitting the targeted marketing offer to the user's mobile device.

The token may be associated with the user identifier. The token may be unique for the user.

The mobile device may transmit signal transmitter identity information extracted from the one or more signals to the server and the server may maps the signal transmitter identity information to a store identifier.

The mobile device may transmit signal transmitter strength to the server and the server may calculate a location for the mobile device within the physical retail store based upon the signal strength. The location for the mobile device may be used to generate the targeted marketing offer.

The one or more signals may be transmitted via one of a plurality of wireless transmitters disposed within the physical retail store. The wireless transmitters may be Bluetooth beacons or Wi-Fi transmitters.

The method may further include:

Receiving activation of the targeted marketing offer from the user at the mobile device;
Transmitting the activation from the mobile device to the server;
The server actuating payment from the user to the retailer for the product(s) relating to the offer; and
In response to payment, the server transmitting confirmation to a retailer apparatus and to the mobile device.

The targeted marketing offer may be generated also based upon location specific information.

The location specific information may include one or more selected from the set of weather, traffic, and local events.

The targeted marketing offer may be generated based on user defined information.

The user defined information may include one or more selected from the set of age, gender, clothing dimensions, food allergies, style tastes and personality traits.

The targeted marketing offer may be generated based on the past activities of the user.

The past activities may include one or more selected from the set of previous products purchased, previous brands purchased, previous movements within the store, and previous spending with the retailer.

According to a further aspect of the invention there is provided a system for generating targeted offers, including:

A user apparatus configured for browsing a web-page served by a retail web server and for retrieving a token associated with the user from a server;
A retail web server configured for capturing user browsing information and for storing an association between a token received from a user apparatus and the user browsing information;
A mobile device configured for receiving one or more signals from one or more signal transmitters within a physical retail store;
A server configured for extracting store identifier information from the one or more signals, for retrieving user browsing information from the retail web server using the extracted store identifier information, for generating a targeted marketing offer for a user based, at least in part, upon the retrieved user browsing information, and for transmitting the targeted marketing offer to a mobile device; and
One or more signal transmitters configured for transmitting signals within a physical retail store for receipt by mobile devices.

According to a further aspect of the invention there is provided a server for generating targeting offers, including:

One or more processors configured for associating a token with a user, for transmitting that token to a user apparatus, for receiving one or more signals received by a mobile device within a physical retail store, for extracting store identifier information from the one or more signals, for retrieving user browsing information from the retail web server using the extracted store identifier information, for generating a targeted marketing offer for a user based, at least in part, upon the retrieved user browsing information, and for transmitting the targeted marketing offer to a mobile device; and
One or more communications apparatuses configured for communicating with the user apparatus, the retail web server, and the mobile device.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention; and

FIGS. 3a, 3b, and 3c:
show a sequence diagram illustrating a method and system in accordance with an embodiment of the invention.

### DETAILED DESCRIPTION OF PREFERRED EMBODIMENTS

The present invention provides a method and system for generating targeted marketing offers.

Beacons are low-powered wireless transmitters that can be easier deployed within a physical location such as a retail store. Beacons typically transmit a low-power wireless signal, which includes identity information for the beacon.

The inventors have discovered that beacons (and other wireless transmitters) could be used to increase in-store user engagement and drive product sales for the retailer.

The inventors have also observed that purchasers of products in-store also commonly undertake research of the products online beforehand. This research may occur on any of the purchasers' devices, which may be desktop computers, laptops, tablets, and smart-phones.

The inventors have developed a system that captures historic online user activity and uses this to generate and transmit a targeted marketing offer for the user's mobile device when the device is triggered by a beacon within a retail store.

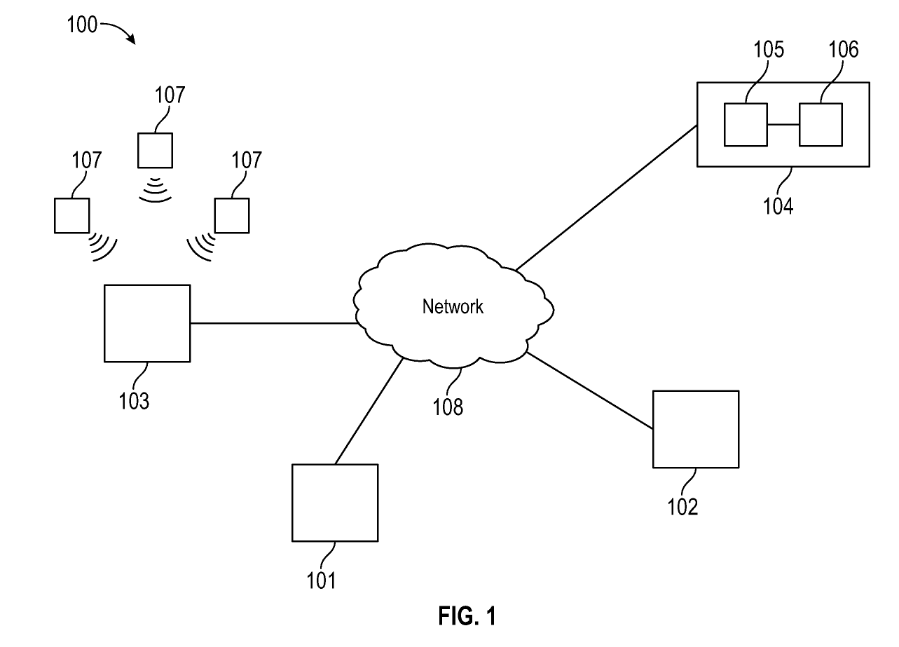

In FIG. 1, a system 100 in accordance with an embodiment of the invention is shown.

A user apparatus 101 is shown. The user apparatus may be a computing device such as a desktop computer, a laptop, a tablet, or a smart-phone.

A retail web server 102 is shown. The retail web server 102 may be a server under the control of a retailer, or it may be a distributed processing network (such as is provided by Amazon AWS). The retail web server 102 may be configured for receiving web requests relating to products for a one retailer or for a plurality of retailers.

A mobile device 103 is shown.

A server 104 is shown. The server 104 may include one or more processors 105 and one or more communications apparatuses 106.

A plurality of wireless transmitters 107 are shown. The wireless transmitters 107 may be beacons (i.e. low power transmitters configured for transmitting identity information), or other transmitters such as Wi-Fi access points. The wireless transmitters 107 may be disposed within a single retailer store.

A communication network 108 is shown. It will be appreciated that the communications network 108 may comprise one or more separate networks or a combination of networks such as LAN, WAN, Internet, or cellular networks.

The user apparatus 101 may be configured for requesting, receiving and displaying web requests during a browsing session to and from the retail web server 102.

The retail web server 102 may be configured for capturing browsing information during the browsing session from the user and associating this information with a token associated with the user.

The one or more processors 105 of the server 104 may be configured for receiving a request for a token from, for example, the user apparatus 101, generating the token and transmitting the token for eventual receipt by the retail web server 102.

The one or more processors 105 of the server 104 may be further configured for receiving one or more signals from the mobile device 103, for extracting store identifier information from the one or more signals, for retrieving browsing information relating to the user of the mobile device 103 from the retail web server 102 using store identifier information and an identifier for the user, for generating a targeted marketing offer based upon, at least, the retrieved browsing information, and for transmitting this offer to the mobile device 103. In one embodiment, the browsing information is retrieved directly from the retail server 102, and in an alternative embodiment, the browsing information is retrieved from a database which in turn has received and stored the browsing information from the retail web server 102.

The one or more communications apparatus 106 of the server 104 may be configured for controlling receipt and transmission between the server 104 and the user apparatus 101, mobile device 103, and retail web server 102 via the communications network 108.

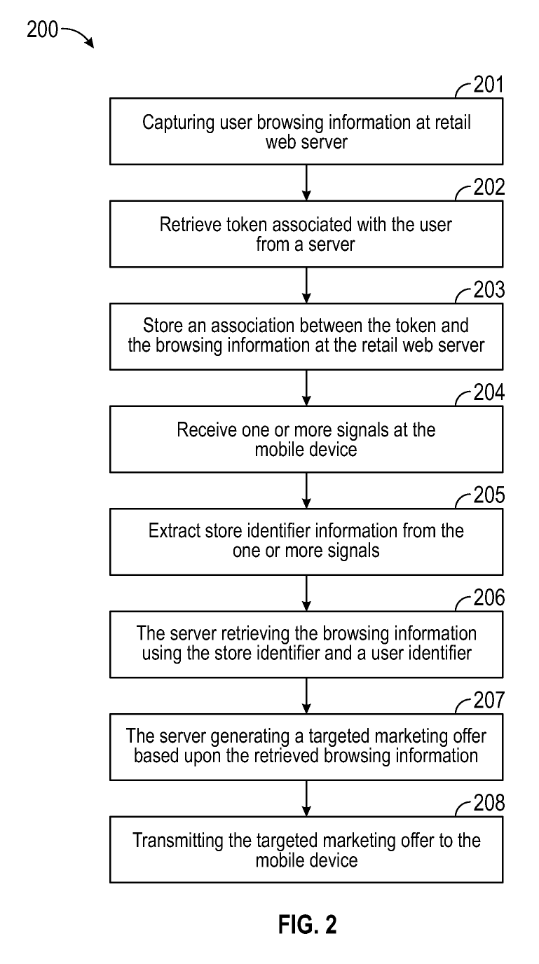

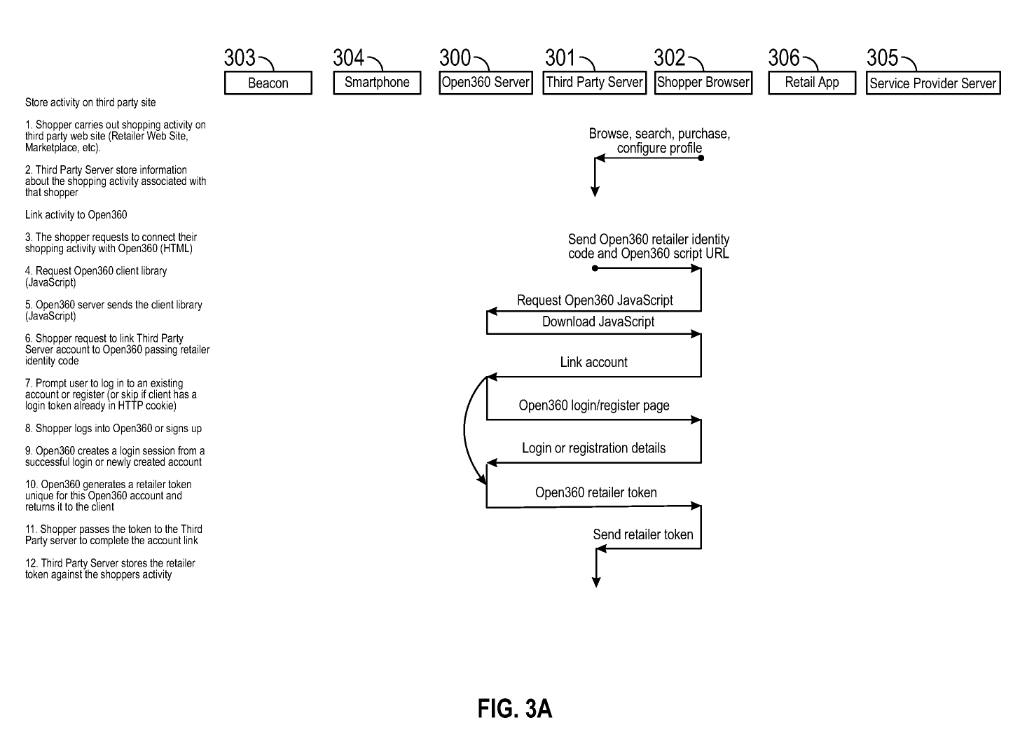

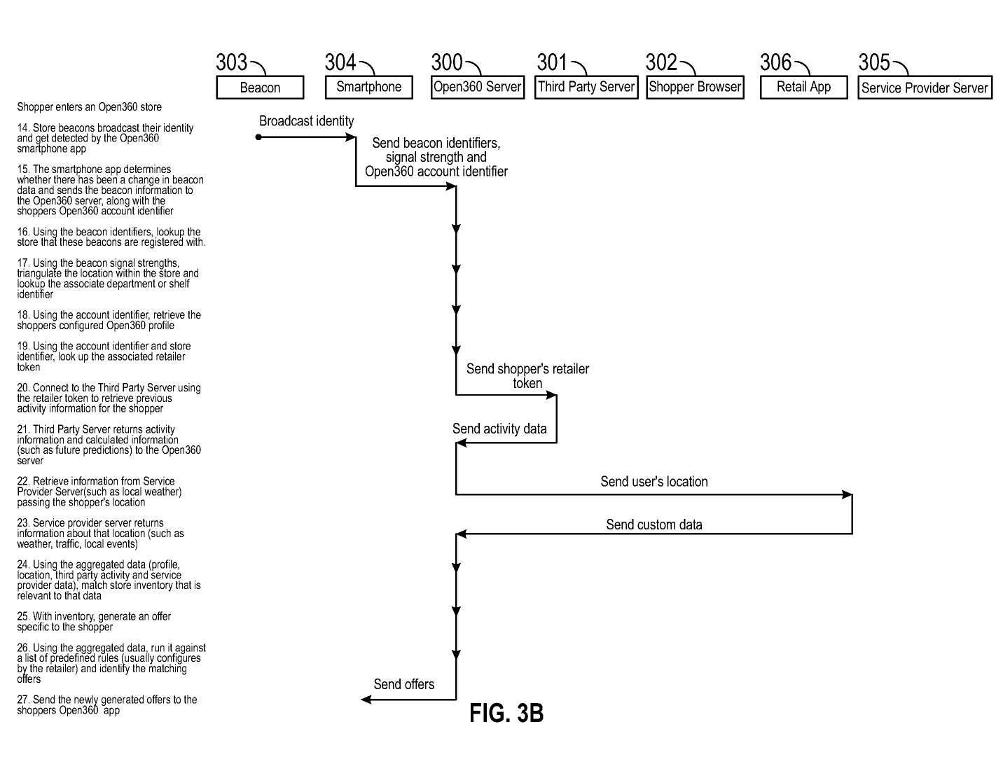

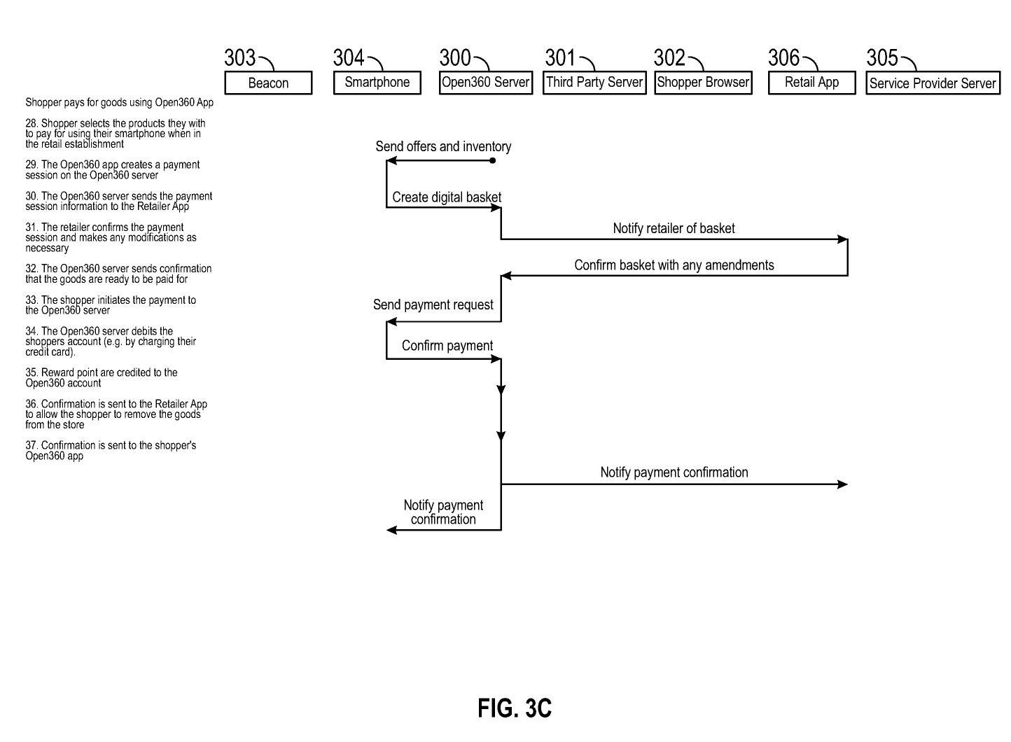

Referring to FIG. 2, a method 200 in accordance with an embodiment of the invention will be described.

In step 201, a user browses a website hosted by a retail web server on a user apparatus. Information relating to this browsing session is captured, preferably, by the retail web server.

In step 202, a token associated with the user is retrieved from a server. The token may be requested by the user apparatus. The user apparatus may receive a code module (such as JavaScript) or link to a code module (e.g. a link to JavaScript, for example, at the server) from the retail web server during the browsing session. Execution of the code module at the user apparatus may specify the retrieval of the token and transmission of the token to the retail web server. The user apparatus may authorise the user with the server to retrieve the token. The authorisation process may involve use of a locally stored identifier relating to an earlier authorisation (such as a cookie), or a login process between the user apparatus and the server.

In step 203, an association is stored between the token and the captured browsing information at the retail web server. The token may have been transmitted from the server to the retail web server via the user apparatus. This transmission process may be controlled by the code module executing on the user apparatus.

In step 204, a mobile device for the user may detect one or more signals. The signals may be transmitted from one or more wireless transmitters which may be disposed within a physical retail store. The wireless transmitters may be beacons such as Bluetooth Low Energy beacons. The one or more signals may include transmitter identifiers uniquely identifying their wireless transmitter. Each transmitter identifier may be associated at the server with a particular physical store and/or a particular location within the store.

In step 205, store identifier information is extracted from the one or more signals. The signals may be transmitted to the server for the store identifier information to be extracted. To extract the store identifier information, the server may map the transmitter identifiers to a store identifier. In addition, to the signals, information about the signals may be transmitted from the mobile device to the server. This signal information may include strength of the signals. The server may utilise strength of the signals and location of the transmitters to triangulate a position for the mobile device within the physical store. In an alternative embodiment, the server receives a GPS-derived signal from the mobile device to utilise in determining the location of the mobile device.

In step 206, the server may retrieve browsing information stored about the user from the retail web server using the store identifier information and using an identifier for the user. The user identifier may be received from the mobile device. The browsing information may be retrieved directly from the retail web server, or indirectly via a database.

In step 207, the server may generate a targeted marketing offer for the user using the retrieved browsing information. The server may also use additional information for generating the targeted marketing offer. The additional information may be pre-stored user information such as demographic information, information related to the location of the user or the store, information related to the time the offer is generated, historical user information relating to the specific retailer, and inventory information relating to the specific retail store.

The server may utilise a set of rules to generate the offer. The rules may be defined, at least in part, by the retailer.

In step 208, the generated targeted marketing offer may be transmitted to the user's mobile device. The offer may be transmitted over a communications network such as a cellular network or a wireless network. The mobile device may receive the offer and display it to the user.

In one embodiment, the user may activate the offer on their mobile device to purchase a product displayed within the offer. Activation of the offer may trigger a purchase process occurring on the mobile device where the user authenticates payment for the product and a product coupon is generated. The product coupon may be transmitted to a retailer apparatus at the retail store. Upon receiving and presenting the product coupon, the user may exit the store with the product without further payment transactions.

Referring to FIGS. 3a, 3b, and 3c, a method and system in accordance with an embodiment of the invention will be described.

This embodiment will be described as Open360.

The system comprises the following components:
a) A centralised Open360 server 300 to allow shoppers' smart-phone devices to authenticate, report location and request personalised offers. The Open360 server 300 can also contact third party servers 301 to gather additional information related to the shopper.
b) A third party server 301 to record activities carried out by a shopper (for example, performing searches on a retailer's web site, or searches in a marketplace representing multiple retailers).
c) A JavaScript library to allow the shopper to link their browser session on the third party web site to their Open360 account. This JavaScript library will allow the browser to request an access token from the Open360 server 300 to store against the user's account or session on the third party server 301.
d) A shopper device 302 to carry out activities on the third party server 301, such as a browser on a desktop computer to perform product searches on the Retailer's web site. This device 302 will allow the third party server's 301 session to be linked to the centralised Open360 server 300 using JavaScript to generate an access token.
e) Beacons 303, for example Bluetooth Low Energy (BLE) beacons. These broadcast their identity to any smart-phones 304 using an Open360 app executing on the smart-phone 304.
f) A smart-phone 304 to allow the shopper to receive and interact with offers when in the store. The smart-phone 304 will listen for beacons 303 and communicate the discovered beacon identifies to the centralised Open360 server 300. This connection may happen over Wifi, 3G, 4G or any other Internet connectivity available (such as an Internet enabled beacon). The signal strength of the beacons 303 will also be sent to aid the indoor positioning by triangulating the user's position.
g) A service provider server 305 for providing information based upon the location of the user. This information might include local weather, details about local events, traffic, or other localised information.
h) A retailer app 306 to enable the retailer to confirm purchases made by the shopper using their Open360 smart-phone app.

The method of this embodiment describing interaction between the above components will now be described.

A shopper uses their shopper device 302 to carry out shopping activity (browsing, searching, purchasing, and configuring their profile) on a third party web site provided by the third party server 301.

The third party server 301 stores information about the shopping activity associated with that shopper.

The shopper requests to connect their shopping activity with Open360 via their shopper device 302. This request may be triggered by an Open360 URL and retailer identity sent within HTML to the shopper.

The Open360 client library is requested by the shopper device 302 from the Open360 server 300.

The Open360 server 300 sends the client library to the shopper device 302.

The shopper via the client library executing on their shopping device 302 requests to link the third party server 301 account to their Open360 account by passing the retailer identity code to the Open360 server 300.

The Open360 server 300 prompts the shopper to log in to an existing account or register (or skip if the client has a login token already in an HTTP cookie).

The shopper logs into Open360 or signs up.

The Open360 server 300 creates a login session from successful login or newly created account.

The Open360 server 300 generates a retailer token unique for the shopper's Open360 account and returns this to the client library at the shopper device 302.

The shopper via the client library at the shopper device 302 passes the token to the third party server to complete the account link.

The third party server 301 stores the retailer token against the shopper's activity.

The next phase occurs when the shopper enters an Open360 store (i.e. a retail store which is using the Open360 technology) with their smart-phone 304.

Their smart-phone 304 will include the Open360 smart-phone app. The shopper may initially configure their app by proceeding through an authentication process (i.e. providing a valid set of credentials, such as email and password, to the Open360 server 300). In response to this process, the Open360 server 300 may return an authorisation token. The shopper may also provide profile information to the Open360 server 300 about themselves via the smart-phone app, or via the shopper device 302. This profile information may include gender, age group, interests and clothing dimensions.

Beacons 303 within the store broadcast their identity and are detected by the Open360 app on the smart-phone 304.

The smart-phone 304 app determines whether there has been a change in beacon data and sends the beacon information to the Open360 server 300 along with the shopper's Open360 account identifier. The beacon information may include beacon identifiers and signal strength.

Using the beacon identifiers, the Open360 server 300 looks up the store that the beacons 303 are registered with and retrieves a store identifier.

The Open360 server 300 may identify the beacons 303 against a known list of beacons and positions.

Using the beacons' signal strengths, it may be possible to determine the location of the smart-phone 304, by triangulation, within the store and the associated department or shelf identifier can be retrieved. When only one beacon is discovered, only the store will be identified.

Using the account identifier and store identifier, the associated retailer token is retrieved.

The third party server 301 is connected to by the Open360 server 300 and the retailer token is used to retrieve previous activity information for the shopper.

The third party server 301 returns activity information, calculated information (such as future predictions about the shopper's interests), and other information unique to the shopper such as price preferences and loyalty information (e.g. revenue within last 90 days) to the Open360 server 300.

Information is then retrieved from the service provider server 305 (such as weather, local news or traffic) relevant to the shopper's location or the store's location.

The server provider server 305 returns information about the location to the Open360 server 300.

Using the aggregated data (profile of the shopper, location, third party activity, and service provider data), store inventory that matches properties of the aggregated data can be identified and an offer automatically generated.

The aggregated data may also be run against a list of predefined rules (which may be configured by the retailer) to match against previously configured offers.

An example of a rule might be:

If the shopper
is [male]
and [is located at] the [movie department]
and browsed [action movies] within [the past 2 months]
and [brought] a [dvd player] within [the past 6 months]
and [it is raining]
then show offer [Action Movie+Popcorn Bundle]

Definition of rule variables:

[male]—a parameter identified from the shopper's Open360 profile
[is located at]—a parameter to denote a beacon position
[movie department]—the department identified from the beacon positioning
[action movies]—a category or feature of a product
[the past 2 months]—a time period of which the condition must be true within
[brought]—an action carried out by the shopper as identified by the Open360 shopping activity or third party service
[dvd player]—a category or feature of a product
[the past 6 months]—a time period of which the condition must be true within.
[it is raining]—a condition that can be determined to be true by the use of a third party service and the location and time of the shopper (e.g. local weather conditions)
[Action Movie+Popcorn Bundle]—the offer to present the shopper when the above conditions are true

The newly generated offers are sent to the shopper's Open360 smart-phone 304 app.

The shopper may also pay for the goods using the Open360 smart-phone 304 app.

When this happens, the shopper selects products they wish to pay for using their smart-phone 304 when in the retail store. In an alternative embodiment, the retail EPOS may be used to select the products.

The Open360 smart-phone 304 app creates a payment session on the Open360 server 300.

The Open360 server 300 sends the payment session information to the Retailer app 306.

The retailer confirms the payment session and makes any further modifications as necessary.

The Open360 server 300 sends confirmation that the goods are ready to the paid for.

The shopper initiates the payment to the Open360 server 300.

The Open360 server 300 debits the shopper's account (e.g. by charging their credit card).

Reward points (i.e. loyalty points) may be awarded to the shopper's Open360 account.

Confirmation is sent to the retailer app 306 to allow the shopper to remove the goods from the store.

Confirmation is sent to the shopper's Open360 app on their smart-phone 304.

In one embodiment, the Open360 server 300 can access other third party services that may be linked to the shopper's Open360 account and information about the shopper, previous activity and predicted future activity can be determined and supplied to the Open360 server 300. Examples may include brand preferences, search history, previous purchases and predicted future purchases (e.g. brought an inkjet printer, it can suggest replacement cartridges in 3 months time).

In one embodiment, the Open360 server 300 stores the shopper's new location activity when they enter the store and will retrieve past location and purchase information from the store, which can be used to improve the offer relevance. For example, returned to the sofa department 3 times within the past month.

In one embodiment, the Open360 server 300 can use the information supplied to locate store inventory that match the shopper's preferences. For example, it can automatically rate some products as highly relevant based on stock levels matching the shopper's size requirement, recent interest in products of the same category and price information for the product. In this scenario, the Open360 server 300 can generate offers automatically against specific products that are available within the store.

Potential advantages of some embodiments of the present invention is that shoppers receive offers in-store which are more likely to drive in-store purchases, shoppers receive offers based upon their historic online browsing, and retailers can customise offers for shoppers based upon current and localised information.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for generating targeted offers to a user of a mobile device, including:
a) capturing user browsing information at a retail web server;
b) retrieving a token associated with the user from a server;
c) storing an association between the token and the browsing information at the retail web server;
d) at a user's mobile device, detecting one or more signals transmitted within a physical retail store;
e) extracting store identifier information from the one or more signals;
f) at the server, retrieving browsing information from the retail web server using the store identifier information and a user identifier;
g) at the server, generating a targeted marketing offer for the user based upon, at least, the retrieved browsing information; and
h) transmitting the targeted marketing offer to the user's mobile device.

2. A method as claimed in claim 1, wherein the token is associated with the user identifier.

3. A method as claimed in claim 2, wherein the token is unique for the user.

4. A method as claimed in claim 1, wherein the mobile device transmits signal transmitter identity information extracted from the one or more signals to the server and wherein the server maps the signal transmitter identity information to a store identifier.

5. A method as claimed in claim 1, wherein the mobile device transmits signal transmitter strength to the server and wherein the server calculates a location for the mobile device within the physical retail store based upon the signal strength.

6. A method as claimed in claim 5, wherein the location for the mobile device is used to generate the targeted marketing offer.

7. A method as claimed in claim 1, wherein the one or more signals are transmitted via one of a plurality of wireless transmitters disposed within the physical retail store.

8. A method as claimed in claim 1, wherein the wireless transmitters are Bluetooth beacons.

9. A method as claimed in claim 1, further including:
Receiving activation of the targeted marketing offer from the user at the mobile device;
Transmitting the activation from the mobile device to the server;
The server actuating payment from the user to the retailer for the product(s) relating to the offer; and
In response to payment, the server transmitting confirmation to a retailer apparatus and to the mobile device.

10. A method as claimed in claim 1, wherein the targeted marketing offer is generated also based upon location specific information.

11. A method as claimed in claim 1, wherein the location specific information includes one or more selected from the set of weather, traffic, and local events.

12. A method as claimed in claim 1, wherein the targeted marketing offer is generated based on user defined information.

13. A method as claimed in claim 1, wherein the user defined information includes one or more selected from the set of age, gender, clothing dimensions, food allergies, style tastes and personality traits.

14. A method as claimed in claim 1, wherein the targeted marketing offer is generated based on the past activities of the user.

15. A method as claimed in claim 1, wherein the past activities includes one or more selected from the set of previous products purchased, previous brands purchased, previous movements within the store, and previous spending with the retailer.

16. A system for generating targeted offers, including:
A user apparatus configured for browsing a web-page served by a retail web server and for retrieving a token associated with the user from a server;
A retail web server configured for capturing user browsing information and for storing an association between a token received from a user apparatus and the user browsing information;
A mobile device configured for receiving one or more signals from one or more signal transmitters within a physical retail store;
A server configured for extracting store identifier information from the one or more signals, for retrieving user browsing information from the retail web server using the extracted store identifier information, for generating a targeted marketing offer for a user based, at least in part, upon the retrieved user browsing information, and for transmitting the targeted marketing offer to a mobile device; and
One or more signal transmitters configured for transmitting signals within a physical retail store for receipt by mobile devices.

17. A server for generating targeting offers, including:
One or more processors configured for associating a token with a user, for transmitting that token to a user apparatus, for receiving one or more signals received by a mobile device within a physical retail store, for extracting store identifier information from the one or more signals, for retrieving user browsing information from the retail web server using the extracted store identifier information, for generating a targeted marketing offer for a user based, at least in part, upon the retrieved user browsing information, and for transmitting the targeted marketing offer to a mobile device; and
One or more communications apparatuses configured for communicating with the user apparatus, the retail web server, and the mobile device.

18. (canceled)
